(19) United States
(12) Patent Application Publication
(10) Pub. No.: US 2013/0093669 A1
(43) Pub. Date: Apr. 18, 2013

(54) APPARATUS AND METHOD FOR CONTROLLING SCREEN IN WIRELESS TERMINAL

(71) Applicant: Samsung Electronics Co., Ltd., Gyeonggi-do (KR)

(72) Inventors: Sang-Wook PARK, Seoul (KR); SeeUooRee HONG, Seoul (KR)

(73) Assignee: Samsung Electronics Co., Ltd., Gyeonggi-do (KR)

(21) Appl. No.: 13/651,781

(22) Filed: Oct. 15, 2012

(30) Foreign Application Priority Data
Oct. 13, 2011 (KR) 10-2011-0105396

(51) Int. Cl. G09G 5/00

(52) U.S. Cl. 345/156

(57) ABSTRACT

An apparatus and method for controlling a screen in a wireless terminal including a bendable display unit for easily controlling the screen, the apparatus including a bendable display unit, a bending detector for detecting bending of the bendable display unit, and a controller for controlling the bendable display unit to up-scale and display data in a non-bent screen region on the bendable display unit when the bendable display unit is bent.

### PRIORITY

This application claims priority under 35 U.S.C. §119(a) to a Korean Patent Application filed in the Korean Intellectual Property Office on Oct. 13, 2011 and assigned Ser. No. 10-2011-0105396, the contents of which are incorporated herein by reference.

### BACKGROUND OF THE INVENTION

1. Field of the Invention

The present invention relates generally to an apparatus and method for controlling a screen in a wireless terminal, and more particularly, to an apparatus and method for allowing convenient control of a screen in a wireless terminal with a flexible display unit.

2. Description of the Related Art

In order to manipulate a User Interface (UI) in conventional tablet Personal Computers (PCs) or wireless terminals having a split screen, a user may manipulate the split screen by touching and dragging a split screen bar displayed on the split screen with a finger tip.

While using a tablet PC having a big screen, a user may grip the tablet PC with both hands because of its large size. The user is required to manipulate a split screen of a tablet PC by moving a split screen bar, with one hand gripping the tablet PC and the other hand performing a touch-and-drag operation.

However, manipulating the split screen by directly touching the screen is an inconvenient operation for the user, and it is difficult to smoothly manipulate the device.

### SUMMARY OF THE INVENTION

An aspect of the present invention is to provide an apparatus and method for allowing convenient control of a screen in a wireless terminal with a bendable, flexible display unit.

An aspect of the present invention is to provide an apparatus and method for allowing manipulation of a UI by bending a bendable, flexible display unit in a wireless terminal with the bendable display unit.

A further another aspect of the present invention is to provide an apparatus and method for promoting up-scaling and displaying of desired data by bending a bendable, flexible display unit in a wireless terminal with the flexible display unit.

According to the present invention, there is provided an apparatus for controlling a screen in a wireless terminal, including a bendable display unit, a bending detector for detecting bending of the bendable display unit, and a controller for controlling the bendable display unit to up-scale and display data in a non-bent screen region on the bendable display unit when the bendable display unit is bent.

According to the present invention, there is provided a method of controlling a screen in a wireless terminal, including detecting bending of a bendable display unit, and up-scaling and displaying data in a non-bent screen region on the bendable display unit when the bendable display unit is bent.

### BRIEF DESCRIPTION OF THE DRAWINGS

The above and other objects, features and advantages of the present invention will become more apparent from the following detailed description when taken in conjunction with the accompanying drawing in which:

FIG. 1 illustrates a wireless terminal according to an embodiment of the present invention;

FIG. 2 illustrates a process of controlling a screen in a wireless terminal according to an embodiment of the present invention; and

FIGS. 3A, 3B, 4A, 4B, 5A and 5B illustrate an operation of controlling a screen in a wireless terminal according to an embodiment of the present invention.

### DETAILED DESCRIPTION OF EMBODIMENTS OF THE INVENTION

Embodiments of the present invention will now be described in detail with reference to the accompanying drawings. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for the sake of clarity and conciseness.

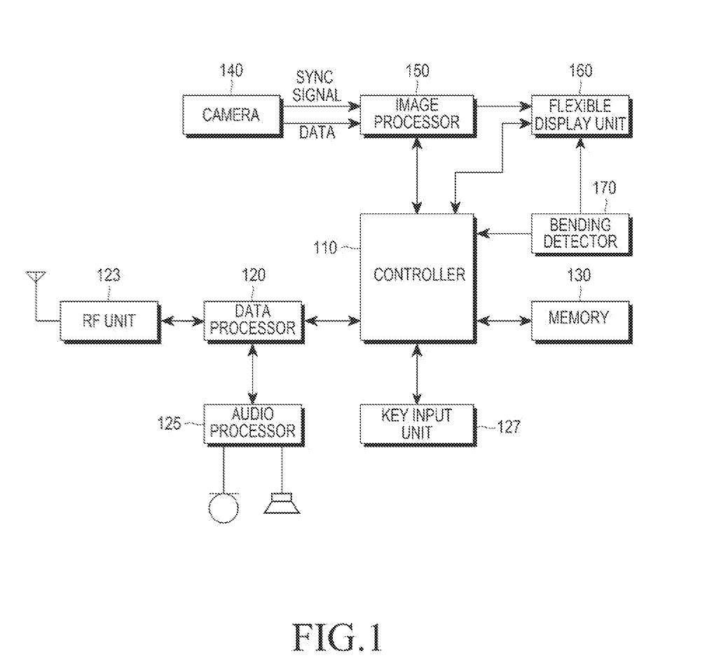

FIG. 1 illustrates a wireless terminal according to an embodiment of the present invention.

Referring to FIG. 1, a Radio Frequency (RF) unit 123 performs a wireless communication function of the wireless terminal. The RF unit 123 includes an RF transmitter (not shown) for up-converting a frequency of a transmission signal and amplifying the up-converted transmission signal and an RF receiver (not shown) for low-noise amplifying a received signal and down-converting a frequency of the amplified received signal. A data processor 120 includes a transmitter (not shown) for coding and modulating the transmission signal and a receiver (not shown) for demodulating and decoding the received signal. In other words, the data processor 120 may include a modem and a codec. The codec includes a data codec for processing information such as packet data, and an audio codec for processing an audio signal such as voice. An audio processor 125 plays a received audio signal output from the audio codec in the data processor 120 and transfers a transmission audio signal received by a microphone to the audio codec in the data processor 120.

A key input unit 127 includes alphanumeric keys (not shown) for inputting alphanumeric information and function keys (not shown) for setting various functions.

A memory 130 may include a program memory (not shown) and a data memory (not shown). The program memory may store programs for controlling a general operation of the wireless terminal and programs for controlling a flexible display unit 160 to down-scale and display data in a bent screen region on the flexible display unit 160 and up-scale and display data in a non-bent screen region on the flexible display unit 160. For at least this reason, the flexible display unit 160 herein also refers to a bendable display unit.

A controller 110 controls the overall operation of the wireless terminal.

When the flexible display unit 160 is bent, the controller 110 controls the flexible display unit 160 to up-scale and display data in a non-bent screen region on the flexible display unit 160 and down-scale and display data in a bent screen region on the flexible display unit 160.

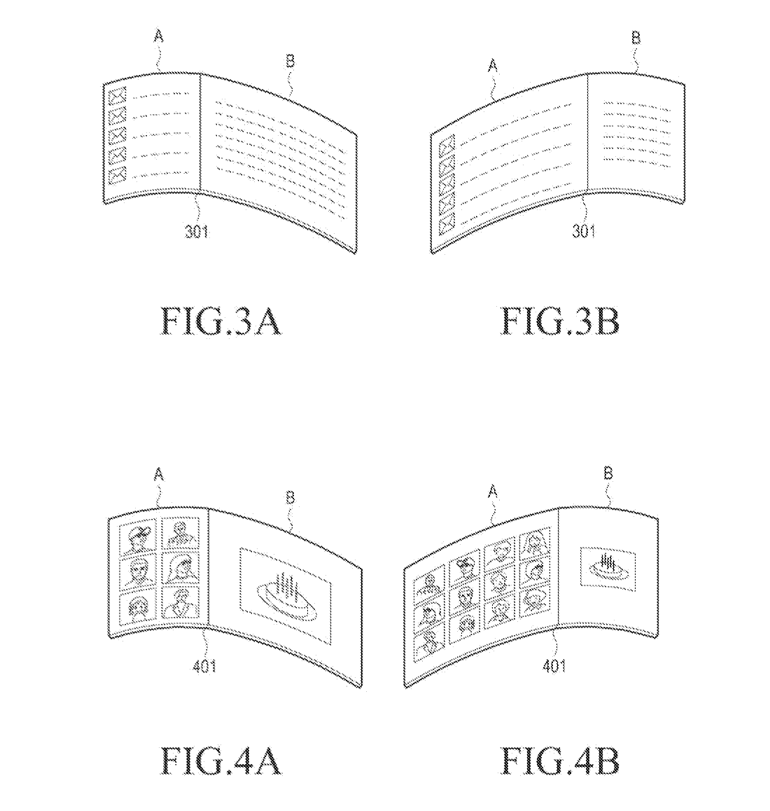

In addition, when the flexible display unit 160 displays relative data in left and right screen regions divided on the flexible display unit 160, if a screen region of the left screen region (illustrated in FIGS. 3A, 3B, 4A and 4B) on the flexible display unit 160 is bent, the controller 110 controls the flexible display unit 160 to expand the right screen region (also illustrated in FIGS. 3A, 3B, 4A and 4B) to the entire non-bent screen region on the flexible display unit 160 and up-scale and display the data relative to the right screen region in the expanded right screen region. Concurrently, the controller 110 controls the flexible display unit 160 to down-scale and display the data relative to the left screen region in the bent left screen region on the flexible display unit 160 to fit the data relative to the left screen region to the reduced size of the bent left screen region.

In addition, if a screen region of the right screen region on the flexible display unit 160 is bent, the controller 110 controls the flexible display unit 160 to expand the left screen region to the entire non-bent screen region on the flexible display unit 160 and up-scale and display the data relative to the left screen region in the expanded left screen region. Concurrently, the controller 110 controls the flexible display unit 160 to down-scale and display the data relative to the right screen region in the bent right screen region on the flexible display unit 160 to fit the data relative to the right screen region to the reduced size of the bent right screen region.

The controller 110 may control the flexible display unit 160 to display the relative data in the left and right screen regions by displaying a bar for discriminating the left screen region from the right screen region on the flexible display unit 160. When the flexible display unit 160 is bent, the controller 110 may control the flexible display unit 160 to display the relative data in bent and non-bent screen regions divided on the flexible display unit 160 by moving the bar to a position at which the bent screen region meets the non-bent screen region.

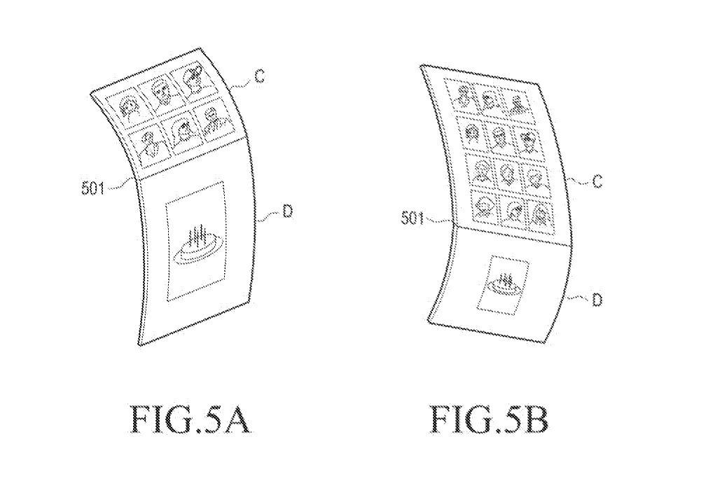

Alternatively, when the flexible display unit 160 displays relative data in upper and lower screen regions (which will be described with reference to FIGS. 5A and 5B) on the flexible display unit 160, if a screen region of the upper screen region on the flexible display unit 160 is bent, the controller 110 may control the flexible display unit 160 to expand the lower screen region to the entire non-bent screen region on the flexible display unit 160 and up-scale and display the data relative to the lower screen region in the expanded lower screen region. Concurrently, the controller 110 controls the flexible display unit 160 to down-scale and display the data relative to the upper screen region in the bent upper screen region on the flexible display unit 160 to fit the data relative to the upper screen region to the reduced size of the bent upper screen region.

When a screen region of the lower screen region on the flexible display unit 160 is bent, the controller 110 may control the flexible display unit 160 to expand the upper screen region to the entire non-bent screen region on the flexible display unit 160 and up-scale and display the data relative to the upper screen region in the expanded upper screen region. Concurrently, the controller 110 controls the flexible display unit 160 to down-scale and display the data relative to the lower screen region in the bent lower screen region on the flexible display unit 160 to fit the data relative to the lower screen region to the reduced size of the bent lower screen region.

The controller 110 may control the flexible display unit 160 to display the relative data in the upper and lower screen regions by displaying a bar for discriminating the upper screen region from the lower screen region on the flexible display unit 160. When the flexible display unit 160 is bent, the controller 110 may control the flexible display unit 160 to display the relative data in bent and non-bent screen regions divided on the flexible display unit 160 by moving the bar to a position at which the bent screen region meets the non-bent screen region.

The flexible display unit 160 is a bendable display device for displaying an image output from an image processor 150 and user data output from the controller 110 on a screen. The bendable display device allows the display to be safely bent, such that the screen is not damaged and maintains the ability to display the output data. The flexible display unit 160 may include a Liquid Crystal Display (LCD), in which case the flexible display unit 160 includes an LCD controller, a memory for storing image data, and an LCD panel. The LCD may serve as an input unit with a touch screen, in which case the flexible display unit 160 may display the numeric keys of the key input unit 127.

The flexible display unit 160 also serves to maintain good image quality even though the flexible display unit 160 is folded or bended, in the manner of paper. Therefore, the flexible display unit 160 is generally different from a glass substrate, and it is able to bend or fold without damage, through the provision of a thin and flexible substrate.

The flexible display unit 160 may include a plurality of sensors mounted on the rear of the flexible display unit 160 so that a bending detector 170 may detect bending of the flexible display unit 160.

The bending detector 170 detects bending of the flexible display unit 160 by using the plurality of sensors assembled on the rear of the flexible display unit 160. Specifically, when the flexible display unit 160 is bent, the bending detector 170 extracts a value of a position on the flexible display unit 160 at which a bent screen region meets a non-bent screen region by using the sensors located at the position at which the bent screen region meets the non-bent screen region, and transfers the extracted position value to the controller 110.

A camera unit 140 includes a camera sensor (not shown)for capturing image data and converting the captured optical signal into an electrical signal, and a signal processor (not shown)for converting an analog image signal captured by the camera sensor into digital data. The camera sensor is assumed herein to be a Charge-Coupled Device (CCD) or Complementary Metal Oxide Semiconductor (CMOS) sensor, and the signal processor may be realized by a Digital Signal Processor (DSP). The camera sensor and the signal processor may be realized in an integrated or a separated manner.

The image processor 150 performs Image Signal Processing (ISP) for displaying image signals output from the camera unit 140 on the flexible display unit 160, and the ISP performs functions such as gamma correction, interpolation, spatial variation, image effects, image scaling, Automatic White Balance (AWB), Automatic Exposure (AE), and Automatic Focusing (AF). The image processor 150 processes the image signals output from the camera unit 140 on a frame basis, and outputs the frame-based image data according to the characteristics and size of the flexible display unit 160.

The image processor 150, which includes a video codec (not shown), compresses frame image data displayed on the flexible display unit 160 by preset coding, and restores (or decompresses) the compressed frame image data into its original frame image data. The video codec may include a Joint Pictures Experts Group (JPEG) codec, Motion Pictures Experts Group 4 (MPEG4) codec, or a Wavelet codec. Assuming that the image processor 150 includes an On-Screen Display (OSD) function, the controller 110 may control the image processor 150 to output OSD data according to the size of a screen on which the data is displayed.

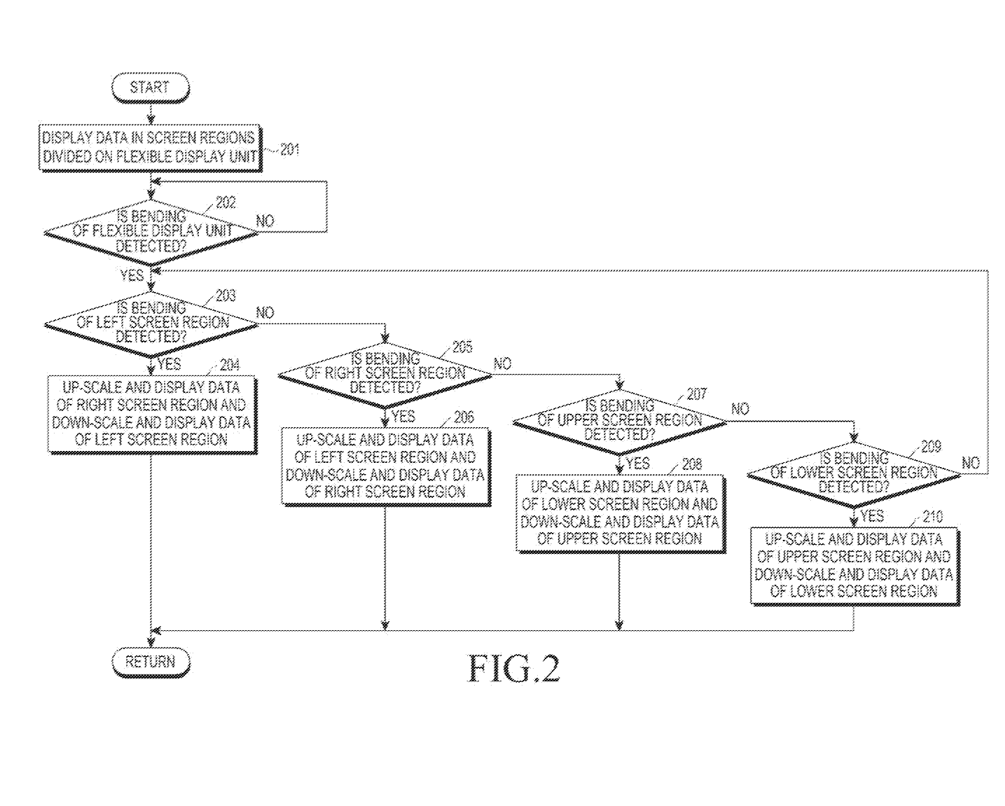

FIG. 2 illustrates a process of controlling a screen in a wireless terminal according to an embodiment of the present invention, and will be described in detail with reference to FIG. 1.

Referring to FIG. 2, in step 201 that displays relative data in left and right screen regions or upper and lower screen regions divided on the flexible display unit 160, if the flexible display unit 160 is bent, the bending detector 170 detects the bending in step 202, extracts a value of a position on the flexible display unit 160 at which a bent screen region meets a non-bent screen region by using the sensors located at the position at which the bent screen region meets the non-bent screen region, and transfers the extracted position value to the controller 110.

Based on the position value received from the bending detector 170, the controller 110 determines the bent screen region and the non-bent screen region on the flexible display unit 160 and controls the flexible display unit 160 to down-scale and up-scale the relative data and respectively display the down-scaled and up-scaled data in the bent screen region and the non-bent screen region.

When the flexible display unit 160 displays the down-scaled and up-scaled data in the bent screen region and the non-bent screen region in step 201, the controller 110 may determine in step 203 that a predetermined screen region of the left screen region on the flexible display unit 160 is bent, based on the position value received from the bending detector 170. If so, in step 204, the controller 110 controls the flexible display unit 160 to expand the right screen region to the entire non-bent screen region on the flexible display unit 160 and up-scale and display the data relative to the right screen region in the expanded right screen region and down-scale and display the data relative to the left screen region in the bent left screen region on the flexible display unit 160 to fit the data relative to the left screen region to the reduced size of the bent left screen region.

In step 205, if the controller 110 determines based on the position value received from the bending detector 170, that a screen region of the right screen region on the flexible display unit 160 is bent, in step 206, the controller 110 controls the flexible display unit 160 to expand the left screen region to the entire non-bent screen region on the flexible display unit 160 and up-scale and display the data relative to the left screen region in the expanded left screen region and down-scale and display the data relative to the right screen region in the bent right screen region on the flexible display unit 160 to fit the data relative to the right screen region to the reduced size of the bent right screen region.

If the flexible display unit 160 displays the relative data in the left and right screen regions by using a bar for discriminating the left screen region from the right screen region, the controller 110 may control the flexible display unit 160 to up-scale and down-scale the relative data in the left and right screen regions by moving the bar to a position on the flexible display unit 160 at which a bent screen region meets a non-bent screen region every time the flexible display unit 160 is bent.

When the flexible display unit 160 displays the relative data in upper and lower screen regions divided on the flexible display unit 160 in step 201, the controller 110 may determine in step 207 that a screen region of the upper screen region on the flexible display unit 160 is bent, based on the position value received from the bending detector 170. If so, in step 208, the controller 110 controls the flexible display unit 160 to expand the lower screen region to the entire non-bent screen region on the flexible display unit 160 and up-scale and display the data relative to the lower screen region in the expanded lower screen region and down-scale and display the data relative to the upper screen region in the bent upper screen region on the flexible display unit 160 to fit the data relative to the upper screen region to the reduced size of the bent upper screen region.

In step 209, if the controller 110 determines based on the position value received from the bending detector 170, that a screen region of the lower screen region on the flexible display unit 160 is bent, in step 210, the controller 110 controls the flexible display unit 160 to expand the upper screen region to the entire non-bent screen region on the flexible display unit 160 and up-scale and display the data relative to the upper screen region in the expanded upper screen region and down-scale and display the data relative to the lower screen region in the bent lower screen region on the flexible display unit 160 to fit the data relative to the lower screen region to the reduced size of the bent lower screen region.

If the flexible display unit 160 displays the relative data in the upper and lower screen regions by using a bar for discriminating the upper screen region from the lower screen region, the controller 110 may control the flexible display unit 160 to up-scale and down-scale the relative data in the upper and lower screen regions by moving the bar to a position on the flexible display unit 160 at which a bent screen region meets a non-bent screen region every time the flexible display unit 160 is bent.

Although it is described in FIG. 2 that the flexible display unit 160 displays relative data in left and right screen regions or upper and lower screen regions divided on the flexible display unit 160, the present invention may be applied even when the flexible display unit 160 displays relative data in upper, lower, left, and right screen regions divided on the flexible display unit 160.

FIGS. 3A, 3B, 4A, and 4B illustrate an operation of controlling a screen in a wireless terminal according to an embodiment of the present invention, in which a flexible display unit displays relative data in left and right screen regions A and B divided on the flexible display unit.

While the flexible display unit is displaying an email list in the left screen region A and the contents of an email selected from the email list in the right screen region B, if a screen region of the left screen region A is bent, as shown in FIG. 3A, the flexible display unit may expand the right screen region B to the entire non-bent screen region to up-scale and display the contents of the selected email in the expanded right screen region B and down-scale and display the email list in the bent left screen region A so as to fit the email list in the bent left screen region A. In this case, a bar 301 for discriminating the left screen region A from the right screen region B is moved to the bent left screen region A and displayed.

While the flexible display unit is displaying an email list in the left screen region A and the contents of an email selected from the email list in the right screen region B, if a screen region of the right screen region B is bent, as shown in FIG. 3B, the flexible display unit may expand the left screen region A to the entire non-bent screen region to up-scale and display the email list in the expanded left screen region A and down-scale and display the contents of the selected email in the bent right screen region B so as to fit the contents of the selected email in the bent right screen region B. In this case, the bar 301 for discriminating the left screen region A from the right screen region B is moved to the bent right screen region B and displayed.

Referring to FIG. 4A, while the flexible display unit is displaying a thumbnail list in the left screen region A and an original photograph of a thumbnail selected from the thumbnail list in the right screen region B, if a screen region of the left screen region A is bent, the flexible display unit may expand the right screen region B to the entire non-bent screen region to up-scale and display the original photograph of the selected thumbnail in the expanded right screen region B and down-scale and display the thumbnail list in the bent left screen region A so as to fit the thumbnail list in the bent left screen region A. In this case, the bar 401 for discriminating the left screen region A from the right screen region B is moved to the bent left screen region A and displayed.

Referring to FIG. 4B, while the flexible display unit is displaying a thumbnail list in the left screen region A and an original photograph of a thumbnail selected from the thumbnail list in the right screen region B, if a screen region of the left screen region A is bent, the flexible display unit may expand the left screen region A to the entire non-bent screen region to up-scale and display the thumbnail list in the expanded left screen region A and down-scale and display the original photograph of the selected thumbnail in the bent right screen region B so as to fit the original photograph of the selected thumbnail in the bent right screen region B. In this case, the bar 401 for discriminating the left screen region A from the right screen region B is moved to the bent right screen region B and displayed.

FIGS. 5A and 5B illustrate an operation of controlling a screen in a wireless terminal according to an embodiment of the present invention, in which a flexible display unit displays relative data in upper and lower screen regions C and D divided on the flexible display unit.

Referring to FIG. 5A, while the flexible display unit is displaying a thumbnail list in an upper screen region C and an original photograph of a thumbnail selected from the thumbnail list in a lower screen region D, if a screen region of the upper screen region C is bent, the flexible display unit may expand the lower screen region D to the entire non-bent screen region to up-scale and display the original photograph of the selected thumbnail in the expanded lower screen region D and down-scale and display the thumbnail list in the bent upper screen region C so as to fit the thumbnail list in the bent upper screen region C. In this case, the bar 501 for discriminating the upper screen region C from the lower screen region D is moved to the bent upper screen region C and displayed.

Referring to FIG. 5B, while the flexible display unit is displaying a thumbnail list in the upper screen region C and an original photograph of a thumbnail selected from the thumbnail list in the lower screen region D, if a screen region of the lower screen region D is bent, the flexible display unit may expand the upper screen region C to the entire non-bent screen region to up-scale and display the thumbnail list in the expanded upper screen region C and down-scale and display the original photograph of the selected thumbnail in the bent lower screen region D, so as to fit the original photograph of the selected thumbnail in the bent lower screen region D. In this case, the bar 501 for discriminating the upper screen region C from the lower screen region D is moved to the bent lower screen region D and displayed.

As is apparent from the foregoing description, the apparatus and method for controlling a screen in a wireless terminal allows the user to up-scale his/her desired display data by conveniently manipulating a UI by bending a flexible display unit included in the wireless terminal.

While the invention has been shown and described with reference to certain embodiments, such as a wireless terminal, thereof, it will be understood by those skilled in the art that various changes in form and details may be made therein without departing from the spirit and scope of the invention as defined by the appended claims and their equivalents.

What is claimed is:

1. An apparatus for controlling a screen in a wireless terminal, comprising:
a bendable display unit;
a bending detector for detecting bending of the bendable display unit; and
a controller for controlling the bendable display unit to up-scale and display data in a non-bent screen region on the bendable display unit when the bendable display unit is bent.

2. The apparatus of claim 1, wherein the bending detector detects a value of a position on the bendable display unit at which a bent screen region meets the non-bent screen region.

3. The apparatus of claim 1, wherein the controller controls the bendable display unit to down-scale and display data relative to a bent screen region in the bent screen region on the bendable display unit.

4. The apparatus of claim 1, wherein, when the bendable display unit displays relative data in left and right screen regions divided on the bendable display unit,
when a screen region of the left screen region is bent, the controller controls the bendable display unit to expand the right screen region to the entire non-bent screen region and up-scale and display data relative to the right screen region in the expanded right screen region, and
when a screen region of the right screen region is bent, the controller controls the bendable display unit to expand the left screen region to the entire non-bent screen region and up-scale and display data relative to the left screen region in the expanded left screen region.

5. The apparatus of claim 4, wherein, when the screen region of the left screen region is bent, the controller controls the bendable display unit to down-scale and display the data relative to the left screen region in the bent left screen region so as to fit the data relative to the left screen region to the reduced size of the bent left screen region, and
when the screen region of the right screen region is bent, the controller controls the bendable display unit to down-scale and display the data relative to the right screen region in the bent right screen region so as to fit the data relative to the right screen region to the reduced size of the bent right screen region.

6. The apparatus of claim 4, wherein the controller controls the bendable display unit to display a bar for discriminating the left screen region from the right screen region and move the bar to a position on the bendable display unit at which a bent screen region meets a non-bent screen region.

7. The apparatus of claim 1, wherein, when the bendable display unit displays relative data in upper and lower screen regions divided on the bendable display unit,
when a screen region of the upper screen region is bent, the controller controls the bendable display unit to expand the lower screen region to the entire non-bent screen region and up-scale and display data relative to the lower screen region in the expanded lower screen region, and
when a screen region of the lower screen region is bent, the controller controls the bendable display unit to expand the upper screen region to the entire non-bent screen region and up-scale and display data relative to the upper screen region in the expanded upper screen region.

8. The apparatus of claim 7, wherein, when the screen region of the upper screen region is bent, the controller controls the bendable display unit to down-scale and display the data relative to the upper screen region in the bent upper screen region so as to fit the data relative to the upper screen region to the reduced size of the bent upper screen region, and
when the screen region of the lower screen region is bent, the controller controls the bendable display unit to down-scale and display the data relative to the lower screen region in the bent lower screen region so as to fit the data relative to the lower screen region to the reduced size of the bent lower screen region.

9. The apparatus of claim 7, wherein the controller controls the bendable display unit to display a bar for discriminating the upper screen region from the lower screen region and move the bar to a position on the bendable display unit at which a bent screen region meets a non-bent screen region.

10. A method of controlling a screen in a wireless terminal, comprising:
detecting bending of a bendable display unit; and
up-scaling and displaying data in a non-bent screen region on the bendable display unit when the flexible display unit is bent.

11. The method of claim 10, wherein the detecting of the bending further comprises detecting a value of a position on the bendable display unit at which a bent screen region meets the non-bent screen region.

12. The method of claim 10, wherein the displaying further comprises down-scaling and displaying data relative to a bent screen region in the bent screen region on the bendable display unit.

13. The method of claim 10, wherein the displaying comprises:
when the flexible display unit displays relative data in left and right screen regions divided on the flexible display unit, when a screen region of the left screen region is bent, expanding the right screen region to the entire non-bent screen region and up-scaling and displaying data relative to the right screen region in the expanded right screen region; and
when a screen region of the right screen region is bent, expanding the left screen region to the entire non-bent screen region and up-scaling and displaying data relative to the left screen region in the expanded left screen region.

14. The method of claim 13, further comprising:
when the screen region of the left screen region is bent, down-scaling and displaying the data relative to the left screen region in the bent left screen region so as to fit the data relative to the left screen region to the reduced size of the bent left screen region; and
when the screen region of the right screen region is bent, down-scaling and displaying the data relative to the right screen region in the bent right screen region so as to fit the data relative to the right screen region to the reduced size of the bent right screen region.

15. The method of claim 13, wherein the bendable display unit displays a bar for discriminating the left screen region from the right screen region and moves the bar to a position on the bendable display unit at which a bent screen region meets a non-bent screen region.

16. The method of claim 10, wherein the displaying comprises:
when the bendable display unit displays relative data in upper and lower screen regions divided on the bendable display unit, when a screen region of the upper screen region is bent, expanding the lower screen region to the entire non-bent screen region and up-scaling and displaying data relative to the lower screen region in the expanded lower screen region; and
when a screen region of the lower screen region is bent, expanding the upper screen region to the entire non-bent screen region and up-scaling and displaying data relative to the upper screen region in the expanded upper screen region.

17. The method of claim 16, further comprising:
when the screen region of the upper screen region is bent, down-scaling and displaying the data relative to the upper screen region in the bent upper screen region so as to fit the data relative to the upper screen region to the reduced size of the bent upper screen region; and
when the screen region of the lower screen region is bent, down-scaling and displaying the data relative to the lower screen region in the bent lower screen region so as to fit the data relative to the lower screen region to the reduced size of the bent lower screen region.

18. The method of claim 16, wherein the bendable display unit displays a bar for discriminating the upper screen region from the lower screen region and moves the bar to a position on the bendable display unit at which a bent screen region meets a non-bent screen region.
